(19) United States
(12) Patent Application Publication
(10) Pub. No.: US 2006/0233419 A1
(43) Pub. Date: Oct. 19, 2006

(54) Image display control method, image display control program, image data recording method and computer-readable medium

(75) Inventor: Masahiro Terada, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJI PHOTO FILM CO., LTD., Asaka-shi (JP)

(21) Appl. No.: 11/391,710

(22) Filed: Mar. 29, 2006

(30) Foreign Application Priority Data
Mar. 30, 2005 (JP) P.2005-097949

(51) Int. Cl. G06K 9/00

(52) U.S. Cl. 382/100; 503/227

(57) ABSTRACT

An image display control method of sequentially switching and displaying a plurality of images in a predetermined time, comprises: acquiring, from a recording media, image data for generating an image to be displayed after the switching in response to a switching instruction for switching the image in the predetermined time; and displaying an image based on the acquired image data in the predetermined time, wherein the predetermined time can be switched into a first time and a second time which is longer than the first time, the image data recorded on the recording media comprise first image data and second image data having a lower compression rate than the first image data, and either the first image data or the second image data are acquired corresponding to the predetermined time at the image data acquiring.

### BACKGROUND OF THE INVENTION

1. Field of the Invention

The present invention relates to an image display control method of sequentially switching and displaying a plurality of images in a predetermined time.

2. Description of the Related Art

For a standard file format of a digital camera which has currently spread, that is, ExifJPEG decides a specification for recording thumbnail image data obtained by reducing original image data together with the original image data obtained by photographing. For example, in the case in which the photographing is carried out by means of a digital camera having a recording pixel number of 6000000, for example, recording is carried out with the original image data having 3000×2000 pixels and thumbnail image data having 160×120 pixels, for example. In the case in which the summary of the image data recorded on recording media is to be confirmed, an image based on the thumbnail image data which can be displayed at a high speed is displayed. In the case in which the image data are to be confirmed in detail, an image based on the original image data is displayed. Thus, the display of images having different sizes has been carried out widely depending on circumstances. Conventionally, it has been required that an image having a large size is displayed at a high speed. Methods described in JP-A-8-77325 and JP-A-11-308569 have been proposed as a method of implementing the requirement, for example.

Moreover, there has conventionally been proposed an apparatus capable of switching and displaying a large number of images at a high speed. According to the apparatus, for example, several ten images can be sequentially switched and displayed as in a flip animation for one second and the summary of all of the images recorded on recording media can be confirmed in a short time. The image to be displayed is instantaneously displayed by the apparatus. Therefore, the picture quality of the image can be reduced. Consequently, it is possible to switch the image at a high speed.

### SUMMARY OF THE INVENTION

It is an object of the invention to provide an image display control method capable of easily searching for a desirable image while confirming the summary of all images recorded on recording media in a short time as in the apparatus.

The invention provides an image display control method of sequentially switching and displaying a plurality of images in a predetermined time, comprising: acquiring, from recording media, image data for generating an image to be displayed after the switching in response to a switching instruction for switching the image in the predetermined time; and displaying an image based on the acquired image data in the predetermined time, wherein the predetermined time can be switched into a first time and a second time which is longer than the first time, the image data recorded on the recording media comprise first image data and second image data having a lower compression rate than the first image data, and either the first image data or the second image data are acquired corresponding to the predetermined time at the image data acquiring.

According to the method, it is possible to easily search for a desirable image while confirming the summary of all of the images recorded on the recording media in a short time.

The invention provides the image display control method, wherein at the image data acquiring step, the first image data are acquired when the predetermined time is the first time, and the second image data are acquired when the predetermined time is the second time.

The invention provides an image data recording method of recording image data on recording media, comprising: compressing the image data at a plurality of compression rates corresponding to a type of the recording media, to generate a plurality of compressed image data; and recording the image data and the compressed image data correspondingly on the recording media.

The invention provides a computer-readable medium including a set of instructions for controlling an image display, said set of instructions comprising: acquiring, from a recording media, image data for generating an image to be displayed after the switching in response to a switching instruction for switching the image in the predetermined time; and displaying an image based on the acquired image data in the predetermined time, wherein the predetermined time can be switched into a first time and a second time which is longer than the first time, the image data recorded on the recording media comprises first image data and second image data having a lower compression rate than the first image data, and either the first image data or the second image data are acquired corresponding to the predetermined time at the image data acquiring. The image display control method can be embodied by installing an image display control program for causing a computer to execute each of the instructions.

The invention provides a computer-readable medium including a set of instructions for recording an image data, said set of instructions comprising: compressing the image data at a plurality of compression rates corresponding to a type of the recording media, to generate a plurality of compressed image data; and recording the image data and the compressed image data correspondingly on the recording media. The image data recording method can be embodied by installing an image data recording program for causing a computer to execute each of the instructions.

### BRIEF DESCRIPTION OF THE DRAWINGS

FIG. 1 is a diagram showing a schematic structure of an image reproducing system according to an embodiment of the invention,

FIG. 2 is a diagram showing a hierarchical structure of recording media M,

FIG. 3 is a view showing an example of a screen to be displayed on a display device 300 in an execution of an image display control program,

FIG. 4 is a flowchart showing an operation of a control portion executing the image display control program,

FIG. 5 is a diagram showing a schematic structure of an image data recording system according to the embodiment of the invention,

FIG. 6 is a flowchart showing an operation of the control portion executing an image data recording program, and

FIG. 7 is a diagram showing an example of information to be recorded on recording media.

### DETAILED DESCRIPTION OF THE INVENTION

An embodiment of the invention will be described below with reference to the drawings.

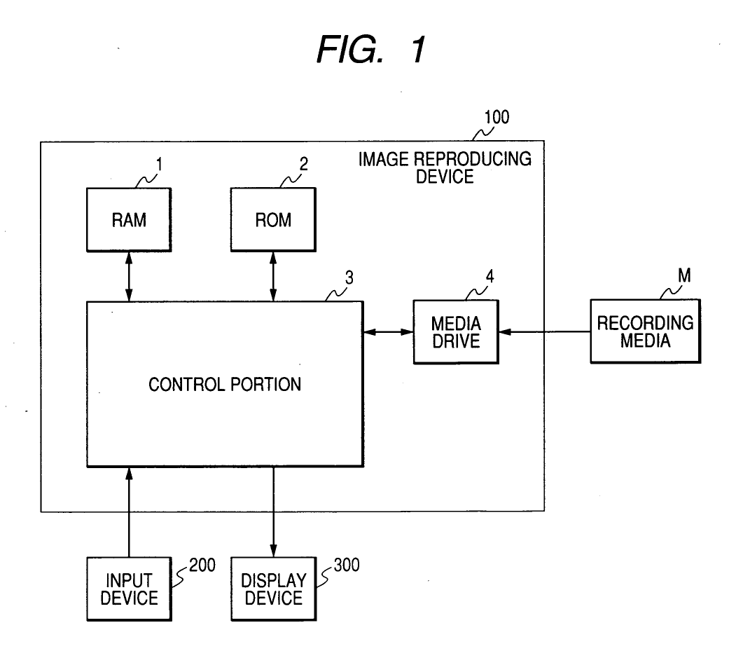

FIG. 1 is a diagram showing a schematic structure of an image reproducing system according to an embodiment of the invention.

The image reproducing system shown in FIG. 1 comprises an image reproducing device 100, an input device 200 such as a keyboard and a mouse connected to the image reproducing device 100, and a display device 300 connected to the image reproducing device 100.

The image reproducing device 100 is a personal computer owned by a user, for example, and includes an RAM 1, an ROM 2, a control portion 3 and a media drive 4.

The control portion 3 is mainly constituted by a processor to be operated in accordance with a predetermined program. The RAM 1 is a work memory for the control portion 3. The ROM 2 serves to store a program to be executed by the control portion 3. The media drive 4 serves to read data recorded in recording media M such as a memory card, a CD-R and a DVD-R.

The recording media M record an image display control program and image data according to the invention.

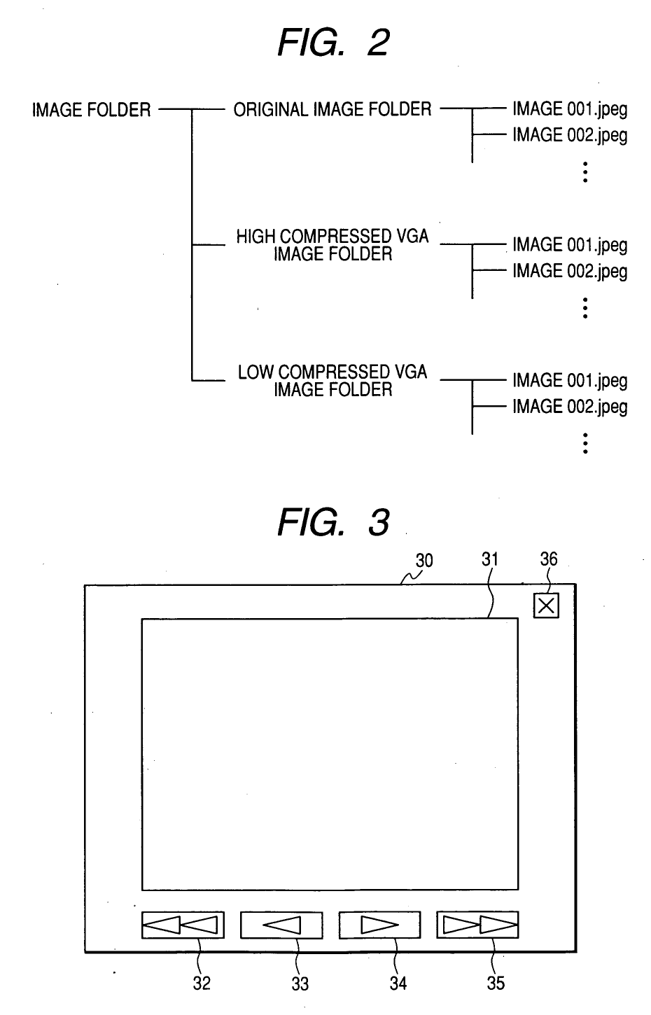

FIG. 2 is a diagram showing a hierarchical structure of the recording media M.

An image folder shown in FIG. 2 is recorded in the recording media M. The image folder includes an original image folder, a high compressed VGA image folder and a low compressed VGA image folder.

The original image folder records original image data to be imaged at a obtained by photographing in a predetermined recording size by means of a digital camera which have names (an image 001. jpeg, an image 002. jpeg, . . . ). The high compressed VGA image folder records, with the same name as the original image data, compressed image data obtained by compressing VGA image data to be image data acquired by resizing the original image data to have a VGA size at a first compression rate without changing a size thereof. The low compressed VGA image folder records, with the same name as the original image data, compressed image data obtained by compressing the VGA image data to be the image data acquired by resizing the original image data to have a VGA size at a second compression rate (Which is lower than the first compression rate) without changing a size thereof. The first compression rate is higher than the second compression rate. In the following, consequently, the compressed image data obtained by a compression at the first compression rate will be referred to as high compressed image data and the compressed image data obtained by the compression at the second compression rate will be referred to as low compressed image data.

Thus, the recording media M record the image display control program, and furthermore, record the original image data and the high compressed image data (corresponding to first image data) and the low compressed image data (corresponding to second image data) which have the VGA size generated from the original image data correspondingly.

Next, an operation of the control portion 3 executing the image display control program will be described with reference to the drawings.

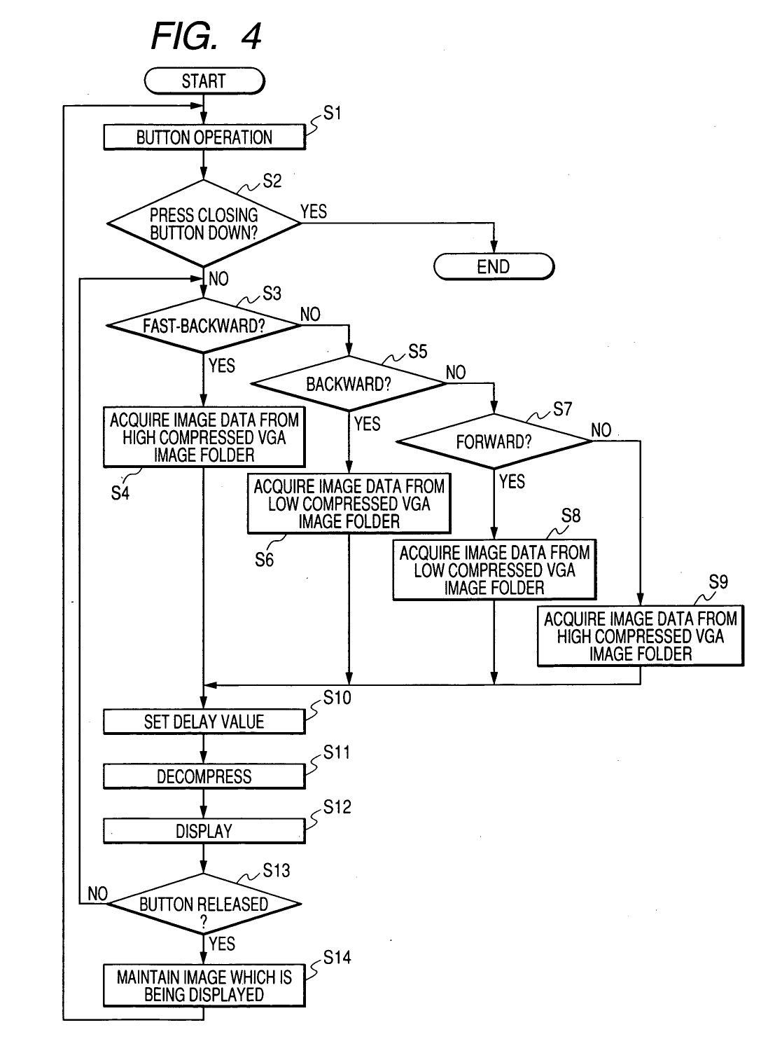

FIG. 3 is a view showing an example of a screen to be displayed on the display device 300 in the execution of the image display control program. FIG. 4 is a flowchart showing the operation of the control portion executing the image display control program.

When the recording media M are attached to the media drive 4 by a user, the image display control program is read from the reading media M and the image display control program thus read is recorded in the ROM 2 through the control portion 3. Then, the control portion 3 executes the image display control program and causes the display device 300 to display a screen 30 shown in FIG. 3.

The screen 30 displays a region 31 in which an image is displayed, a fast-backward button 32 for giving a high-speed switching instruction for sequentially switching and displaying an image in a first time (which is set to be 0.1 second, for example) in reverse order to recording order on the recording media M, a backward button 33 for giving a low-speed switching instruction for sequentially switching and displaying an image in a second time (which is set to be 0.5 second, for example) that is longer than the first time in the reverse order to the recording order on the recording media M, a forward button 34 forgiving a low-speed switching instruction for sequentially switching and displaying an image in the second time in order of record on the recording media M, a fast-forward button 35 for giving a high-speed switching instruction for sequentially switching and displaying an image in the first time in order of the record on the recording media M, and a button 36 for giving an instruction to close the screen 30 and to end the image display control program.

Then, any of the buttons is pressed down with a mouse by the user (S1). The pressed button is the closing button (S2: YES), the control portion 3 ends the image display control program.

On the other hand, if the pressed button is a button other than the closing button (S2: NO) and the pressed button is the fast-backward button 32 (S3: YES), the control portion 3 acquires, from a high compressed VGA image folder of the recording media M, high compressed image data in two image data (the high compressed image data and low compressed image data) for generating an image to be displayed in the region 31 of the screen 30 after switching (S4).

If the pressed button is the backward button 33 (S5: YES), the control portion 3 acquires, from a low compressed VGA image folder of the recording media M, the low compressed image data in the two image data (the high compressed image data and the low compressed image data) for generating an image to be displayed in the region 31 of the screen 30 after the switching (S6).

If the pressed button is the forward button 34 (S7: YES), the control portion 3 acquires, from the low compressed VGA image folder of the recording media M, the low compressed image data in the two image data (the high compressed image data and the low compressed image data) for generating an image to be displayed in the region 31 of the screen 30 after the switching (S8).

If the pressed button is the fast-forward button 35 (S7: NO), the control portion 3 acquires, from the high compressed VGA image folder of the recording media M, the high compressed image data in the two image data (the high compressed image data and the low compressed image data) for generating an image to be displayed in the region 31 of the screen 30 after the switching (S9).

After the high compressed image data or the low compressed image data are acquired, the control portion 3 sets a delay value to be an image display time corresponding to the type of the button which is pressed down by the user (S10) and decompresses the high compressed image data or the low compressed image data which are acquired (S11), and causes the display device 300 to display an image based on the high compressed image data or the low compressed image data after the decompression for only the set display time (S12).

If any of the buttons other than the closing button is continuously pressed down by the user (S13 :NO), the control portion 3 repeats the processings from S3 to S12. Consequently, an image of low picture quality based on the high compressed image data recorded on the recording media M is sequentially switched and displayed at an interval of 0.1 second in reverse order to recording order while the fast-backward button 32 is pressed down. Moreover, an image of high picture quality based on the low compressed image data recorded on the recording media M is sequentially switched and displayed at an interval of 0.5 second in the reverse order to the recording order while the backward button 33 is pressed down. Furthermore, an image of high picture quality based on the low compressed image data recorded on the recording media M is sequentially switched and displayed at an interval of 0.5 second in the recording order while the forward button 34 is pressed down. In addition, an image of low picture quality based on the high compressed image data recorded on the recording media M is sequentially switched and displayed at an interval of 0.1 second in the recording order while the fast-forward button 35 is pressed down.

On the other hand, if the press-down of any of the buttons other than the closing button is interrupted by the user (S13 YES), the control portion 3 brings an image which is being displayed into a display state irrespective of the delay value (S14). If the button operation is carried out again at S1, a processing corresponding to the same operation is performed.

In the case in which an instruction for sequentially switching and displaying an image in a short display time is given, thus, it is possible to carry out a high-speed processing by sequentially switching and displaying an image based on the high compressed image data. When the high-speed processing can be carried out, it is possible to grasp a rough position of a desirable image from a large number of images or to roughly see a large number of images in a short time, for example.

On the other hand, in a short display time, it is necessary to carry out the fast-forward and the fast-backward many times to find a desirable image in order to display the same image at S14 in FIG. 4. This work is complicated. By carrying out the processing of switching and displaying an image in a longer display time than the short display time as in the embodiment at the same time, therefore, it is possible to bring a state in which a high-speed switching instruction is given to display an image placed in a close position to a desirable image and to give a low-speed switching instruction in this state, thereby searching for the desirable image easily, for example. In the embodiment, in the case in which the low-speed switching instruction is given, an image of high picture quality based on the low compressed image data is switched and displayed. In addition to an advantage that the desirable image can be found easily, therefore, it is also possible to obtain an advantage that the image can be confirmed in a state of high picture quality.

As described above, according to the image reproducing device 100 in accordance with the embodiment, it is possible to carry out a conveniently proper use, for example, to utilize high-speed switching when confirming the summary of a large number of images recorded on the recording media M and to utilize low-speed switching when confirming the details of the images. In any case, the image is displayed with the same number of pixels. Therefore, there is no problem in that the image is small and is seen with difficulty.

While the image at S12 is displayed exactly at S14 in FIG. 4 in the example, this is not restricted. In the case in which the displayed image is based on the high compressed image data at S12, for example, an image based on the low compressed image data recorded on the recording media M maybe displayed corresponding to the high compressed image data at S14.

Next, description will be given to a method of recording data on the recording media M.

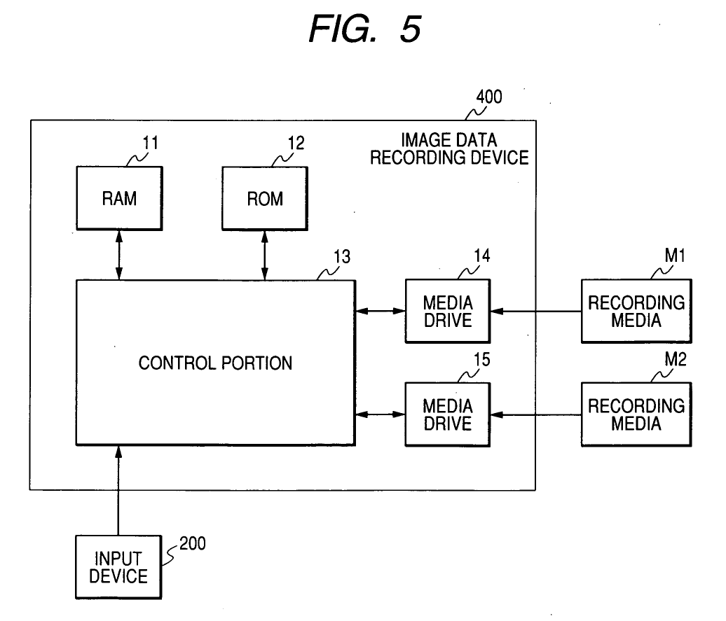

FIG. 5 is a diagram showing a schematic structure of an image data recording system according to the embodiment of the invention. The image data recording system serves to record image data photographed by means of a digital camera and recorded on a memory card by a user on other recording media such as a CD-R and a DVD-R, thereby executing a service to be offered to the user.

An image reproducing system shown in FIG. 5 comprises an image data recording device 400 and an input device 200 such as a key board and a mouse connected to the image data recording device 400.

The image data recording device 400 is a computer provided in a store for executing the service, for example, and includes an RAM 11, an ROM 12, a control portion 13, a media drive 14 and a media drive 15.

The control portion 13 is mainly constituted by a processor to be operated in accordance with a program including an image data recording program according to the invention. The RAM 11 is a work memory for the control portion 13. The ROM 12 serves to store a program to be executed by the control portion 13. The media drive 14 serves to read data recorded on recording media Ml such as a memory card, a CD-R and a DVD-R offered from the user. The media drive 15 serves to record data on empty recording media M2 such as a CD-R and a DVD-R to be offered to the user.

The recording media M1 record, with a name, original image data (corresponding to image data) having a predetermined number of pixels (in an SVGA size) which are obtained by photographing through a digital camera by the user.

An operation of the control portion 13 executing an image data recording program will be described below with reference to the drawings.

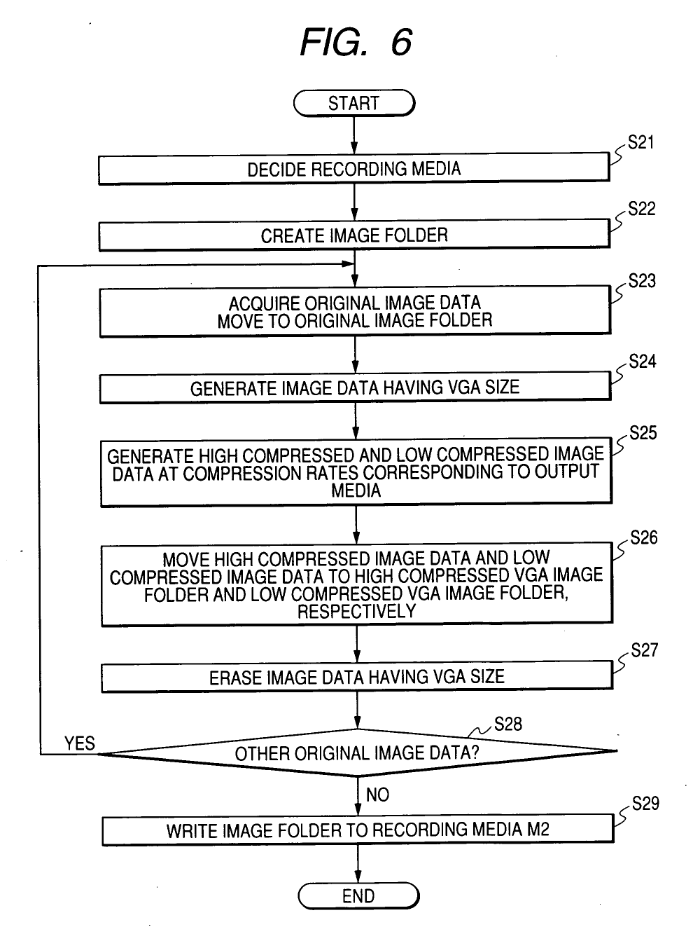

FIG. 6 is a flowchart showing the operation of the control portion 13 executing the image data recording program.

When the recording media M1 are attached to the media drive 14 and the recording media M2 are attached to the media drive 15, the control portion 13 decides the type of the recording media M2 (S21). Next, the control portion 13 creates, on the RAM 11, an original image folder, a high compressed VGA image folder and a low compressed VGA image folder which are shown in FIG. 2 (S22)

Next, the control portion 13 acquires the original image data recorded on the head of the recording media M1 through the media drive 14 and moves the original image data thus acquired to the original image folder (S23). Next, the control portion 13 expands the acquired original image data through the RAM 11 and resizes the expanded data into a VGA size, and compresses a data volume, thereby generating VGA image data on the RAM 11 (S24).

In reproduction through the image reproducing device 100, 10 high compressed imaged a taper second are to be read, for example. In the reproduction through the image reproducing device 100, moreover, two low compressed image data per second are to be read, for example. On the other hand, the recording media M2 have a reading rate which is varied depending on a type thereof. For this reason, if a reading rate of a CD-R is set to be 400 kbps and that of a DVD-R is set to be 600 kbps, for example, it is necessary to determine a compression rate in such a manner that a data volume of the high compressed image data is set to be equal to or smaller than 40 kb and that of the low compressed image data is set to be equal to or smaller than 200 kb in the case in which the recording media M2 are the CD-R. In the case in which the recording media M2 are the DVD-R, furthermore, it is necessary to determine the compression rate in such a manner that the data volume of the high compressed image data is set to be equal to or smaller than 60 kb and that of the low compressed image data is set to be equal to or smaller than 300 kb.

Therefore, the control portion 13 determines a compression rate for generating the high compressed image data and a compression rate for generating the low compressed image data corresponding to a type (a reading rate) of the recording media M2 decided at S21, and compresses the VGA image data at the two compression rates without changing a size thereof and thus generates the high compressed image data and the low compressed image data (S25). Then, the control portion 13 gives the same name as the original image data to the high compressed image data and moves the same image data to the high compressed VGA image folder, and gives the same name as the original image data to the low compressed image data and moves the same image data to the low compressed VGA image folder (S26). Consequently, a correspondence of the original image data to the high compressed image data and the low compressed image data which are generated therefrom is carried out in the image folder.

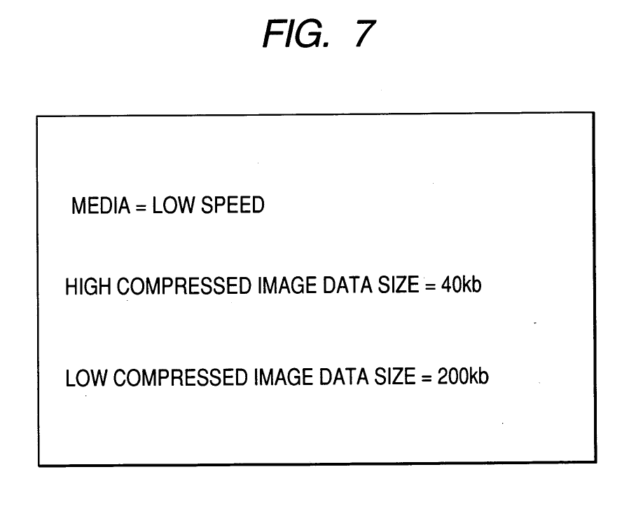

Next, the control portion 13 erases the VGA image data from the RAM 11 (S27). If other original image data which have not generated the high compressed image data and the low compressed image data are present in the recording media M1 (S28: YES), the processing is returned to S23. On the other hand, if the other original image data which have not generated the high compressed image data and the low compressed image data are not present in the recording media M1 (S28: NO), the image folder generated in the RAM 11, the image display control program and information shown in FIG. 7 are recorded on the recording media M2 through the media drive 15 (S29). In the information shown in FIG. 7, “media” indicates a reading rate of the recording media M2, “high compressed image data size” indicates a data volume of the high compressed image data recorded on the recording media M2, and “low compressed image data size” indicates a data volume of the low compressed image data recorded on the recording media M2.

By offering the recording media M2 recording data to the user, thus, the user can confirm an image by using the image reproducing device shown in FIG. 1.

In the explanation with reference to FIG. 6, the VGA image data are once generated at S24. In the case in which the original image data naturally have the VGA size, this processing is not required. In this case, it is preferable to directly compress the original image data without changing a size thereof, thereby generating the high compressed image data and the low compressed image data at S25.

In the case in which the original image data have the VGA size, and furthermore, a data volume of the low compressed image data to be generated is equal to that of the original image data, the processing of generating the low compressed image data from the original image data is not required. In this case, the original image data are the low compressed image data. Therefore, it is preferable to carry out a processing of copying the original image data on the low compressed VGA image folder at S26.

While the original image data are compressed at the two compression rates to generate the high compressed image data and the low compressed image data in the embodiment, moreover, it is also possible to carry out a compression at a plurality of compression rates which is not restricted to two, thereby generating a plurality of compressed image data.

According to the invention, it is possible to provide an image display control method capable of easily searching for a desirable image while confirming the summary of all images recorded on recording media in a short time.

The entire disclosure of each and every foreign patent application from which the benefit of foreign priority has been claimed in the present application is incorporated herein by reference, as if fully set forth.

What is claimed is:

1. An image display control method of sequentially switching and displaying a plurality of images in a predetermined time, comprising:
acquiring, from a recording media, image data for generating an image to be displayed after the switching in response to a switching instruction for switching the image in the predetermined time; and
displaying an image based on the acquired image data in the predetermined time,
wherein the predetermined time can be switched into a first time and a second time which is longer than the first time,
the image data recorded on the recording media comprise first image data and second image data having a lower compression rate than the first image data, and
either the first image data or the second image data are acquired corresponding to the predetermined time at the image data acquiring.

2. The image display control method according to claim 1,
wherein at the image data acquiring, the first image data are acquired when the predetermined time is the first time, and the second image data are acquired when the predetermined time is the second time.

3. An image data recording method of recording image data on recording media, comprising:
compressing the image data at a plurality of compression rates corresponding to a type of the recording media, to generate a plurality of compressed image data; and
recording the image data and the compressed image data correspondingly on the recording media.

4. A computer-readable medium including a set of instructions for controlling an image display, said set of instructions comprising:
acquiring, from a recording media, image data for generating an image to be displayed after the switching in response to a switching instruction for switching the image in the predetermined time; and
displaying an image based on the acquired image data in the predetermined time,
wherein the predetermined time can be switched into a first time and a second time which is longer than the first time,
the image data recorded on the recording media comprises first image data and second image data having a lower compression rate than the first image data, and
either the first image data or the second image data are acquired corresponding to the predetermined time at the image data acquiring.

5. A computer-readable medium including a set of instructions for recording an image data, said set of instructions comprising:
compressing the image data at a plurality of compression rates corresponding to a type of the recording media, to generate a plurality of compressed image data; and
recording the image data and the compressed image data correspondingly on the recording media.
